(19) United States
(12) Patent Application Publication
(10) Pub. No.: US 2004/0242424 A1
(43) Pub. Date: Dec. 2, 2004

(54) Inducing nematode protection for plants

(76) Inventor: A Harry J. Rajamannan, Minneapolis, MN (US)

Correspondence Address: Herman H. Bains, 6101 Tracy Avenue, Minneapolis, MN, 55436, US

(21) Appl. No.: 10/448,828

(22) Filed: May 30, 2003

(51) Int. Cl. A01N 63/00; A01N 55/02; A01N 59/26

(52) U.S. Cl. 504/164; 424/601; 504/165

(57) ABSTRACT

A systemic inducer for inducing resistance to nematode infestation comprising a nutrient combined with microorganism substance extracted from microorganisms. The nutrient or fertilizer includes at least a phosphoric acid, and the salts thereof, a phosphorous acid and the salts thereof, or the salts of phosphorus, potassium, calcium, sodium, magnesium, manganese, zinc, copper and iron. The microorganism substance may be extracted from fungus, bacteria or virus. The systemic inducer may be applied to stems and leaves of plants. Alternatively, the systemic inducer may be applied to soil to elicit a response via the roots of the plants. Finally, the systemic inducer may be injected into the stem or pseudo stem of the plants.

### FIELD OF INVENTION

This invention relates to compounds that can induce resistance to plants to ward off nematode infestations.

### BACKGROUND OF THE INVENTION

Fertilizer are added to soil or sprayed on leaves to supply nutrients to grow crops. Phosphorus needed by plant is applied today in many forms. They are either phosphate salts derived from phosphoric acid or phosphite salts derived from phosphorous acid or the acids themselves.

Phosphate fertilizers have been on the market for several decades and phosphite fertilizers have been on the market in Australia and Europe since 1990. Phosphites to be used as fungicides was also patented as early as 1978 by U.S. Pat. No. 4,075,324.

Merck Index (M. Windhols, Ed 1983), 10^{th} edition monograph No. 1678) describes calcium phosphite as a fertilizer. Many scientific papers have been published since then on the use of phosphite (also called phosphonates) fertilizers and phosphate fertilizers and these products are in public domain (Lovatt, Carol J. 1991, 1992).

Phosphorous acids have been used to fertilize soils in Australia since 1980's. So phosphorous acids in themselves and salts of these acids called phosphites or phosphonates (Whiley et al; 1992) have been in use since 1990's and their use as fertilizers are in public domain.

Nematocides have been applied since the 1950's to control nematodes that attack the plants. These chemical pesticides not only contaminate the environment, pose a danger to workers, leave traces of pesticides in the produce consumed, but also become quite useless as these pathogens rapidly develop resistance to these chemical agents. Methyl bromide used currently to sterilize soils is being taken off the market as it is claimed to destroy the ozone layers in the sky.

Besides phosphates and phosphites elements, fertilizers containing potassium, calcium, magnesium, manganese, zinc, copper, iron or sodium have been used as fertilizers for several decades in many forms of salts and these fertilizers are also in public domain.

U.S. Pat. No. 6,372,238 discloses a process for implanting dry implant sticks into banana and plantain plants for providing nutrients and improving resistance to plant pathogens. The nutrient is slowly released over time and the implant provided reduction of infection by certain pathogens. However, the implant did not obtain the results of the composition of the present invention.

### SUMMARY OF THE INVENTION

An object of this invention is to provide a systemic inducer for plants including a nutrient material and live bacteria, fungi, or viruses or bacterial, fungal or viral extracts for inducing systemic resistance in plants to resist nematode attacks to the roots.

In the embodiment disclosed, the nutrients or fertilizers are phosphoric acids, phosphorous acids, sulfuric acid, hydrocholoric or other inorganic and organic acids, phosphates, phosphites, sulfates or salts of calcium, magnesium, potassium, manganese, zinc, copper, iron or sodium. Microorganismic substances alive or in an extracted or hydrolyzed form are combined with the fertilizer material and applied to plants to provide the systemic resistance to nematodes and nematode infestation.

The systemic inducer may be applied to the stem, leaves of plants. The systemic inducer may also be injected into the stem or pseudo stem of the plants.

### DESCRIPTION OF THE PREFERRED EMBODIMENT

Plants have the ability to ward off infestation by nematodes to a certain degree. Some varieties have natural resistance built in to ward off severe infections and some varieties do not have this ability.

The plants' inherent ability to develop resistance is called “systemic acquired resistance”. Any material that is applied to plants for plants to develop resistance is called “inducers”. So applying certain inducers can elicit certain plants to develop systemic resistance. This is a new field of investigation and development.

The closest parallel process is akin to a human developing resistance to a particular disease after being vaccinated. Simple salts such as phosphites, phosphates and salicylates are known to provide a certain degree of immunity to plants.

We have discovered that certain natural compounds like bacterial, fungal and viral extracts or the organisms themselves when combined with phosphoric acids, phosphorous acids or phosphite fertilizers or phosphate fertilizers can induce 100% systemic resistance in plants such that the need for applying nematocides to these plants or to the soil to manage nematode infestation is obviated.

In other words, we have developed products comprising organisms or extracts of these microorganisms combined with phosphoric acids, phosphorous acids, sulfuric acid, hydrochloric acid or other inorganic and organic acids, phosphates, phosphites, sulfates or salts of calcium, magnesium, potassium, manganese, zinc, copper, iron or sodium induce plants to develop enough resistance naturally to ward off nematode infections such that no pesticides need to be applied.

The present invention provides a systemic resistance inducer that is obtained by combining a phosphorous acid and salts thereof, phosphoric acid and salts thereof or the salts of calcium, magnesium, potassium, zinc, manganese, copper, iron and sodium with extracts of microorganisms. The systemic inducer is applied to plants as a foliar application, or applied to the soil on which the plants are planted or injected into the stem or pseudo stem of these plants. These extracts or the microorganisms do not by themselves cause induction so the induction takes place only when these extracts are used in combination with the fertilizers listed above. Growth enhancers or regulators such as betaine, benzothio diazole, jasmonic acid, cytokinin, auxin and gibberellins, beta amino butyric acid may be combined to relieve the stress caused by the induction program. Salicylates, oxalates, napthaletes have also showed some induction of resistance and can also be combined with nutrients.

### EXAMPLES

### Example 1

Microorganisms were grown in a medium and allowed to die by attenuating them with formaldehyde or exposing to microwaves or hydrolyzed with acids, and the extracts obtained from these organisms were tested for induction of resistance against nematodes in various plants such as strawberry, tomato and banana. These plants thus treated were then challenged by exposing the plants to nematodes. The plants suffered severe infestation. But when these same extracts were combined with a phosphate or phosphite or calcium nitrate or magnesium sulfate and applied to a new set of plants in the same manner of the application of extracts alone, all plants resisted the infestation of nematodes.

### Example 2

The specific microorganisms such as pseudomonas trichoderma species, bacillus subtilis; rhodotorulum species, xanthomonas species, plant growth promoting Rhyzobacteria such as IN 937b and SE 34 were specifically cultured, hydrolyzed and used as is or in combination with a calcium phosphite, potassium phosphate, calcium citrate on a set of plants. Such plants include lettuce, strawberry, tomato, and banana.

Three applications were made at two week intervals routinely during the growing season of strawberry and tomatoes and monthly for 12 months on bananas plants. In banana plants, injections were continued for 12 months with monthly injections with no nematocide applied to the soils. Roots from these plants were gathered and analyzed for the presence of nemtodes. Results are shown on Table I.

### Example 3

These microorganisms used in Experiment 2 were ground up in a dyno mill type KDL (manufactured by Willy A. Bachofenag Maschinen Fabrik Basle, Switzerland) to 5 to 1 mu size and these extracts containing proteins, peptides and ribonucleotides and deoxyribonucleotides were then combined with same fertilizers as used in Example 2 and then sprayed on the same list of plants as in Example 2, but in the case of banana plants the product was injected monthly into the pseudo stem of the banana plants for 12 months. The results in bananas took 6 months to elicit the resistance against nematodes.

On tomatoes and strawberries the effect was within 1 month. New root flush was measured and there were no nematode attacks in the roots.

### Example 4

Extracts from marigold were combined with potassium phosphite and calcium phosphite plus the microorganism extracts and used in field trials to evaluate nematode by plants on tomato, banana, strawberries the combinations out performed the extracts by themselves or the marigold extracts or the fertilizer by themselves.

What is claimed is:

1. A liquid systemic inducer composition for plants for inducing resistance to infestation by nematodes comprising a plant nutrient selected from a group consisting of phosphoric acid, phosphorus acid or salts thereof, or the salts of an element selected from the group consisting phosphorous, calcium, potassium, magnesium, manganese, sodium, sulfur, copper, iron, cobalt; combined with a microoganismic substance selected from the group consisting of live, extracted, or hydrolyzed for the purpose of inducing resistance to nematode infestation.

2. A method of providing and applying a systemic inducer to plants comprising preparing a nutrient selected from the group consisting phosphoric acid and phosphorous acid and the salts thereof, or salts of an element selected from the group consisting of phosphorus, potassium, calcium, potassium, magnesium, manganese, sodium, sulfur, copper, iron, combined with microorganismic substance selected from the group consisting of bacteria, fungi viruses, and bacterial extract, fungal extract or viral extract applying the systemic inducer to plants for the purpose of inducing resistance to nematode infestation.

3. A systemic inducer as defined in claim 1 wherein the phosphorus acid is phosphorous acid and salts thereof, and the combined product is below a pH of 3.5.

4. The systemic inducer as defined in claim 1 wherein the microorganismic substance comprises Bacillus, sp.

5. The systemic inducer as defined in claim 1 wherein the microorganismic substance comprises microorganisms which are hydrolyzed to extract the proteins and peptides therefrom.

6. The systemic inducer as defined in claim 1 wherein the microorganismic substance comprises microorganisms which are hydrolyzed and then ground up sufficiently to extract nucleotides therefrom including deoxyribonucleotides and ribonucleotides.

7. The systemic inducer as defined in claim 1 including a growth enhancer selected from the group consisting of betaine, cytokinin, iso-nicotinic acid, benzothiadizole, beta-amino-butyric acid, gibberellins, auxin and jasmonic acid.

8. The systemic inducer as defined in claim 1 including extracts from marigold to additionally induce strong resistance to nematodes.

9. The method as defined in claim 2 wherein the systemic inducer is applied to the stems, and leaves of the plants.

10. The method as defined in claim 2 wherein the systemic inducer is applied to the soil where plants are growing to elicit a response in the plants via the roots of the plants.

11. The method as defined in claim 2 wherein the systemic inducer is injected into the stems or pseudo stems of the plants.

12. The method as defined in claim 2 wherein the systemic inducer is injected into bananas or plantains.

13. The systemic inducer composition as defined in claim 2 wherein the nutrient is phosphoric acid or the salts thereof

14. The systemic inducer composition as defined in claim 2 wherein the nutrient is phosphorous acid or the salts thereof

15. The systemic inducer composition as defined in claim 2 wherein the nutrient is the salts of phosphorus, potassium, calcium, sodium, magnesium, manganese, zinc, copper and iron.

16. The systemic inducer composition as defined in claim 1 including salicylic acid or its salts, oxalic acid or its salts.

17. The systemic inducer as defined in claim 1 wherein the phosphorus acid comprises hypophosphorous acid and the salts thereof, and wherein the composition has a pH below 3.5.

18. The systemic inducer as defined in claim 1 wherein the phosphorus acid comprises polyphosphorous acid and the salts thereof, and wherein the composition has a pH below 3.5.

19. The systemic inducer as defined in claim 1 wherein the phosphorus acid comprises polyhypophosphorous acid and the salts thereof, and wherein the composition has a pH below 3.5.

20. The systemic inducer as defined in claim 1 wherein the microorganismic substance comprises a microorganisms including Xanthomonas sp.

21. The systemic inducer as defined in claim 1 wherein the microorganismic substance comprises microorganisms including Rhodotorulum sp.

22. The system inducer as defined in claim 1 wherein the microorganismic substance comprises Trichoderma sp.

23. The systemic inducer as defined in claim 1 wherein the microorganismic substance comprises Pseudomonas, sp.

24. The systemic inducer as defined in claim 1 wherein the microorganismic substance comprises Rhyzobacterium such as IN 937b or SE34 species.
